(19) United States
(12) Patent Application Publication
(10) Pub. No.: US 2016/0080899 A1
(43) Pub. Date: Mar. 17, 2016

(54) AUTOMATIC DELIVERY OF PERSONALIZED DIGITAL ARTIFACTS

(71) Applicant: Michelle Fisher, Marina Del Rey, CA (US)

(72) Inventor: Michelle Fisher, Marina Del Rey, CA (US)

(73) Assignee: Miichelle Fisher, Marina Del Rey, CA (US)

(21) Appl. No.: 14/867,328

(22) Filed: Sep. 28, 2015

Related U.S. Application Data
(63) Continuation of application No. 11/944,267, filed on Nov. 21, 2007.

(51) Int. Cl. H04W 4/02; G06Q 30/02; H04L 29/08; G06Q 40/00

(52) U.S. Cl. CPC H04W 4/02; G06Q 40/12; G06Q 30/0267; H04L 67/06

(57) ABSTRACT

A method and system for sending an artifact to a mobile communication device of a user. In one implementation, the method includes receiving a request from an application to send an artifact to a mobile communication device of a user; retrieving personal information from a user profile of the user; retrieving a transaction history of the user, the transaction history including a history of transactions made by the user through the mobile communication device; selecting an artifact to send to the mobile communication device based on the user profile and the transaction history of the user; and sending the selected artifact to the mobile communication device.

### CROSS-REFERENCE TO RELATED APPLICATIONS

This application clams priority to and is a continuation of U.S. patent application Ser. No 11/944,267, filed January Nov. 21, 2007, titled “METHOD AND APPARATUS FOR DELIVERING INFORMATION TO A MOBILE COMMUNICATION DEVICE BASED ON CONSUMER TRANSACTIONS” which is incorporated by reference herein in its entirety.

### FIELD OF INVENTION

The present invention relates to data communications and wireless devices.

### BACKGROUND OF THE INVENTION

Mobile communication devices—e.g., cellular phones, personal digital assistants, and the like—are increasingly being used to conduct payment transactions as described in U.S. patent application Ser. No. 11/933,351, entitled “Method and System For Scheduling A Banking Transaction Through A Mobile Communication Device”, and U.S. patent application Ser. No. 11/467,441, entitled “Method and Apparatus For Completing A Transaction Using A Wireless Mobile Communication Channel and Another Communication Channel, both of which are incorporated herein by reference. Such payment transactions can include, for example, purchasing goods and/or services, bill payments, and transferring funds between bank accounts.

### BRIEF SUMMARY OF THE INVENTION

In general, in one aspect, this specification describes a method for sending an artifact to a mobile communication device of a user. The method includes receiving a request from an application to send an artifact to a mobile communication device of a user; retrieving personal information from a user profile of the user; retrieving a transaction history of the user, the transaction history including a history of transactions made by the user through the mobile communication device; selecting an artifact to send to the mobile communication device based on the user profile and the transaction history of the user; and sending the selected artifact to the mobile communication device.

Particular implementations can include one or more of the following features. The selected artifact can comprise one or more of an advertisement, receipt, ticket, coupon, media, or content. The application can be an application running on the mobile communication device. The application can comprise a payment transaction application that permits a user to perform one or more of the following services including bill payment, fund transfers, or purchases through the mobile communication device. The request from the application to send an artifact can be generated automatically through a point-of-sale device. The request from the application to send an artifact can be generated based on user input received through the mobile communication device. The transaction history of the user can be updated with each transaction performed by the user on the mobile communication device. Sending the selected artifact to the mobile communication device can comprise sending a uniform resource locator (URL) to the mobile communication device that links to the artifact. The mobile communication device can be a cellular phone or a wireless personal digital assistant (PDA).

In general, in another aspect, this specification describes a communication system including a management server that is configured to receive a request from an application to send an artifact to a mobile communication device of a user; retrieve personal information from a user profile of the user; retrieve a transaction history of the user, the transaction history including a history of transactions made by the user through the mobile communication device; select an artifact to send to the mobile communication device based on the user profile and the transaction history of the user; and send the selected artifact to the mobile communication device.

The details of one or more implementations are set forth in the accompanying drawings and the description below. Other features and advantages will be apparent from the description and drawings, and from the claims.

### BRIEF DESCRIPTION OF THE DRAWINGS

FIG. 1 illustrates a block diagram of a communication system including a wireless mobile communication device and a management server in accordance with one implementation.

FIG. 2 illustrates one implementation of the wireless mobile communication device of FIG. 1.

FIG. 3 illustrates one implementation of the management server in the communication system of FIG. 1.

FIG. 4 illustrates one implementation of a user profile database.

FIG. 5 illustrates one implementation of a method for detecting a user transaction on a mobile communication device.

FIG. 6 illustrates one implementation of a method for sending an artifact to a mobile communication device.

FIG. 7 illustrates correlation of a user profile information with transaction history information in accordance with one implementation.

FIG. 8 illustrates one implementation of an artifact database.

FIG. 9 illustrates a block diagram of a communication system including a wireless mobile communication device and a management server in accordance with one implementation.

Like reference symbols in the various drawings indicate like elements.

### DETAILED DESCRIPTION OF THE INVENTION

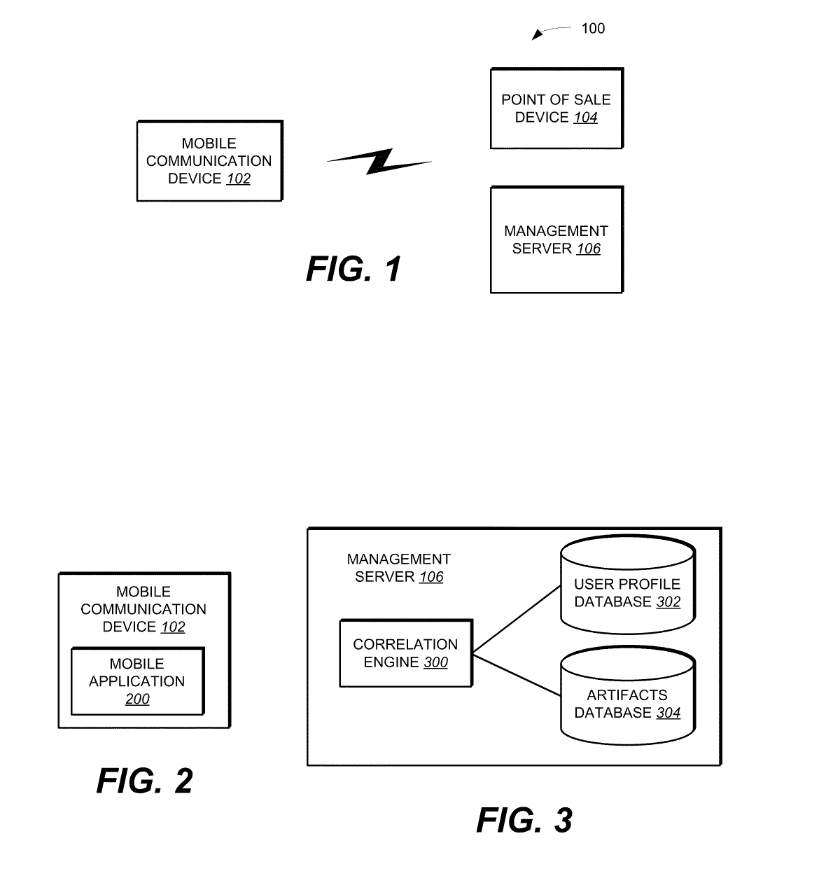

FIG. 1 illustrates one implementation of a communication system 100. The communication system 100 includes a hand-held, wireless mobile communication device 102 a point-of-sale device 104 and a management server 106. In one implementation, the mobile communication device 102 includes a mobile application (discussed in greater detail below) that permits a user of the mobile communication device 102 to conduct payment transactions. Payment transactions can include, for example, using contactless payment technology at a retail merchant point of sale (e.g., through point of sale device 104), using mobile/internet commerce (e.g., purchase tickets and products, etc.), storage of payment information and other digital artifacts (e.g., receipts, tickets, coupons, etc.), storage of banking information (payment account numbers, security codes, PIN's, etc.), and accessing banking service (account balance, payment history, bill pay, fund transfer, etc.), and so on. The mobile communication device 102 can be a cellular phone, a wireless personal digital assistant (PDA), or other wireless communication device.

In one implementation, the mobile application running on the mobile communication device 102 is configured to receive artifacts (e.g., advertisements, receipts, tickets, coupons, media, content, and so on) from the management server 106. In one implementation, the management server 106 sends artifacts to the mobile application based on user profile information and/or a transaction history (or payment trends) associated with a user of the mobile communication device 102. In this manner, a user can receive artifacts through a mobile communication device that are more relevant to the likes and tastes of the user, and which are more likely to be acted upon by the user. In general, the management server 106 can send artifacts in response to a request from the mobile application or other application running on another device—e.g. point-of-sale device 104.

FIG. 2 illustrates one implementation of the mobile communication device 102. The mobile communication device 102 includes a mobile application 200 that (in one implementation) is provided to the mobile communication device 102 through a remote server (e.g., remote server 106). In one implementation, the mobile application is a Mobile Wallet application available from Mobile Candy Dish, Inc., of Berkeley, CA. In one implementation, the mobile application is a hosted service, as described in U.S. patent application Ser. No. 11/939,821, entitled “Method and System For Securing Transactions Made Through a Mobile Communication Device”, which is incorporated herein by reference. In one implementation, the mobile application 200 is configured to send requests to the management server for artifacts based on user input, e.g., received though a keypad (not shown) of the mobile communication device 102. Requests to the management server 106 can also be automated, via proximity-based services, e.g., consumer tapping (or in close proximity) an LBS/contactless/RFID enabled phone against a smart poster (RFID/Bluetooth/LBS enabled, etc.), kiosk, or other device.

FIG. 3 illustrates one implementation of the management server 106. As shown in FIG, 3, the management server 106 includes a correlation engine 300, a user profile database 302, and an artifacts database 304. The correlation engine 300 can correlate user profile information (e.g., location, gender, age, interest, affiliations, etc.) stored in the user profile database 302 with other data (historical payment transactions, real-time payment transactions, etc.) stored in the artifacts database 304, and/or location of a user to provide more relevant targeting parameters for which to target, identify and distribute relevant artifacts to a user. In one implementation, the management server 106 is a server that is maintained by Mobile Candy Dish, Inc.

In one implementation, the user profile database 302 is continually updated with information pertaining to the user—e.g., location, payment history, transaction history, and the like. In addition, the artifacts database 304 can be continually updated with new artifacts that can be sent to users—e.g., users that are subscribed to, e.g., the Mobile Wallet application. For example, metadata can be associated to artifacts stored in the artifacts database 304. The metadata can be leveraged to trigger a secondary call-to-action, e.g., to encourage user behavior. For example, it may be desired for a user to enter an email address, accept coupon/rewards, opt-in for alerts and notification, etc. When an artifact is sent to a user, the metadata associated with the artifact can provide the additional dynamic next steps (e.g., through a user interface screen) to provoke the desired user action.

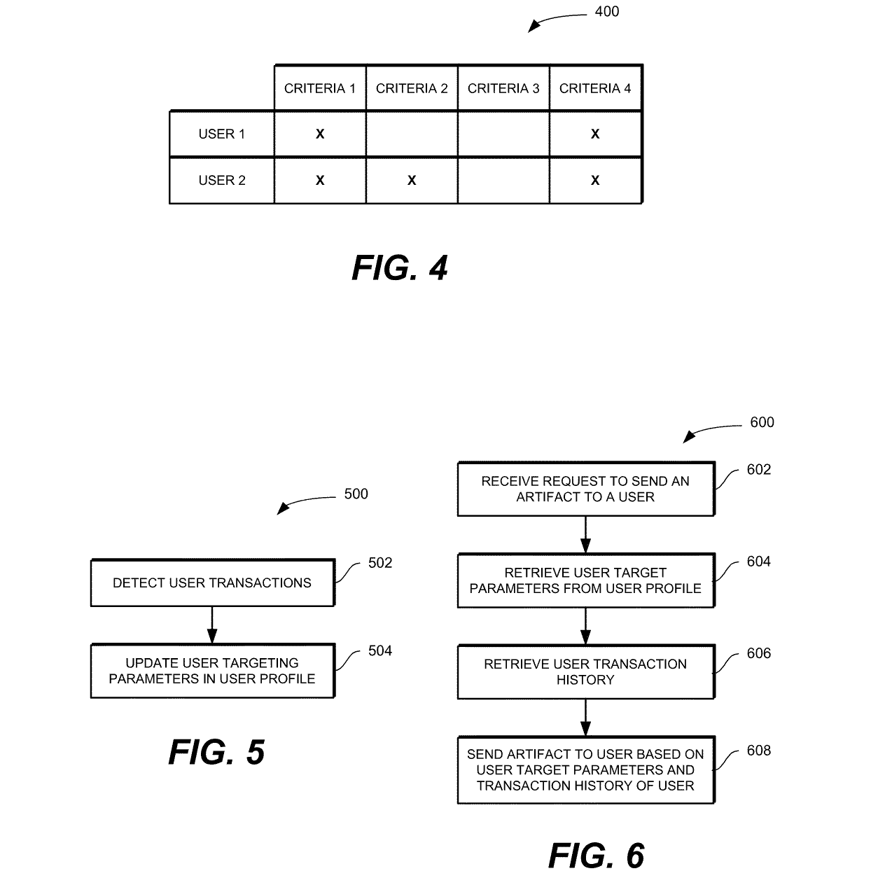

FIG. 4 illustrates one example of the user profile database 302 including user profiles for USER 1 and USER 2. As discussed above, in one implementation, the user profile database is continually updated based on transactions of a user. Accordingly, the user profile database 302 includes a plurality of targeting parameter fields—e.g., targeting parameter fields 1-4—that define targeting parameters that have been satisfied by (or apply to) a user. That is, USER 1 satisfies targeting parameters 1 and 4, while USER 2 satisfies targeting parameters 1, 2, and 4. In general, the user profile database 302 includes other fields (not shown) for storing other attributes associated with users—e.g., personal information. The artifacts database 304 can similarly include targeting parameters that correspond to each artifact. And in one implementation, the correlation engine 300 (FIG. 3) performs correlations between user-data targeting parameters and content targeting parameters in order to match relevant artifacts/content to a specific user profile based on various content distribution rules.

FIG. 5 illustrates a method 500 for managing a user profile database (e.g., user profile database 302). A user transaction on a mobile communication device is detected (e.g., by correlation engine 300) (step 502). The user transaction can be a payment transaction, a fund transfer, or other type of transaction made through a mobile communication device. In response to the user transaction, targeting parameters associated with a user profile of the user is updated (e.g., by correlation engine 300) (step 504). Updating the targeting parameters in a user profile permits more relevant artifacts to be sent to a user based on transactions made by a user through a mobile communication device. In general, as usage of mobile communication devices for payment transactions increases in everyday use, the techniques described herein will permit more relevant artifacts to be sent to users than conventional systems.

FIG. 6 illustrates one implementation of a method 600 for sending an artifact to a mobile communication device of a user. A request to send an artifact to a user is received (e.g., by correlation engine 300) (step 306). The request can be a request generated from a user or be an automated request generated from a point-of-sale device, kiosk, or other device. In general, the artifact can be an advertisements, receipt, ticket, coupon, media, content, and so on. User target parameters from a user profile of the user are retrieved (e.g., by correlation engine 300) (step 604). A transaction history of the user is retrieved (e.g., by correlation engine 300) (step 606). An artifact is sent (from the management server) to the user based on the user target parameters and the transaction history of the user (step 608).

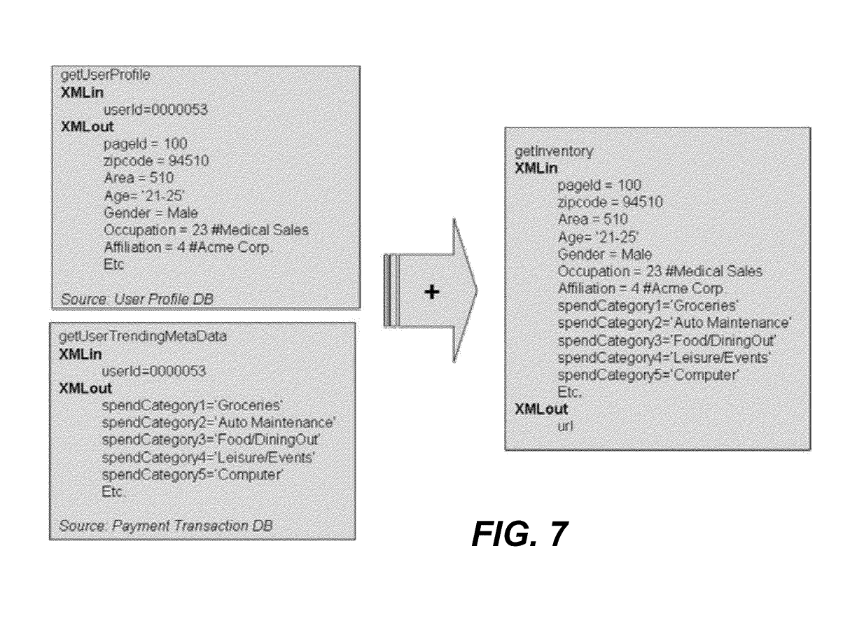

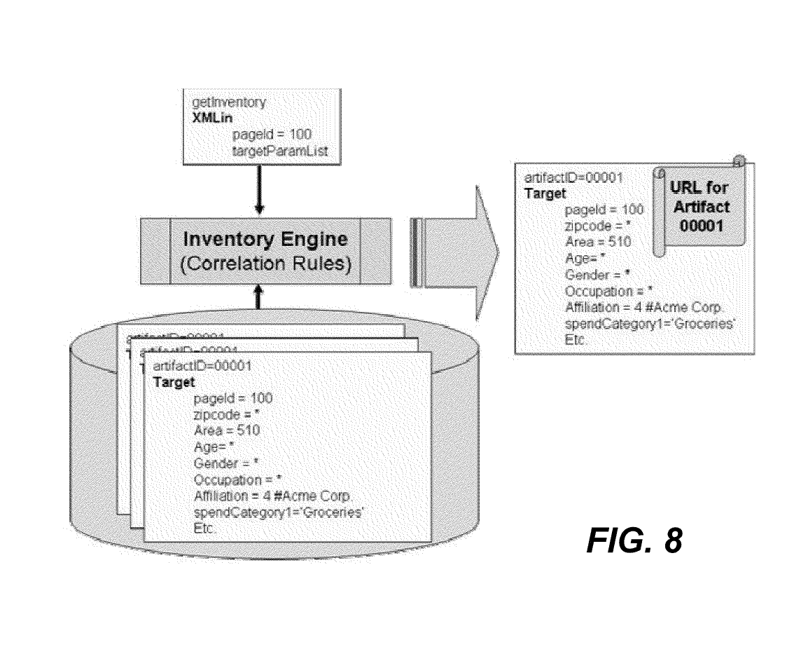

FIG. 7 illustrates one example of the correlation between a user profile and a payment transaction history of a user that is performed by a correlation engine (e.g., correlation engine 300). In one implementation, the correlation engine correlates user profile information and payment transaction history information using extensible markup language (XML). FIG. 8 illustrates one implementation of an artifact database. As discussed above, in one implementation, one or more target parameters are associated with each artifact—for example, an artifact can have target parameters that correspond to a pageid, zipcode, area, age, gender, occupation, affiliation, and so on. In one implementation, artifacts are sent to user via a link to a uniform resource locator (URL).

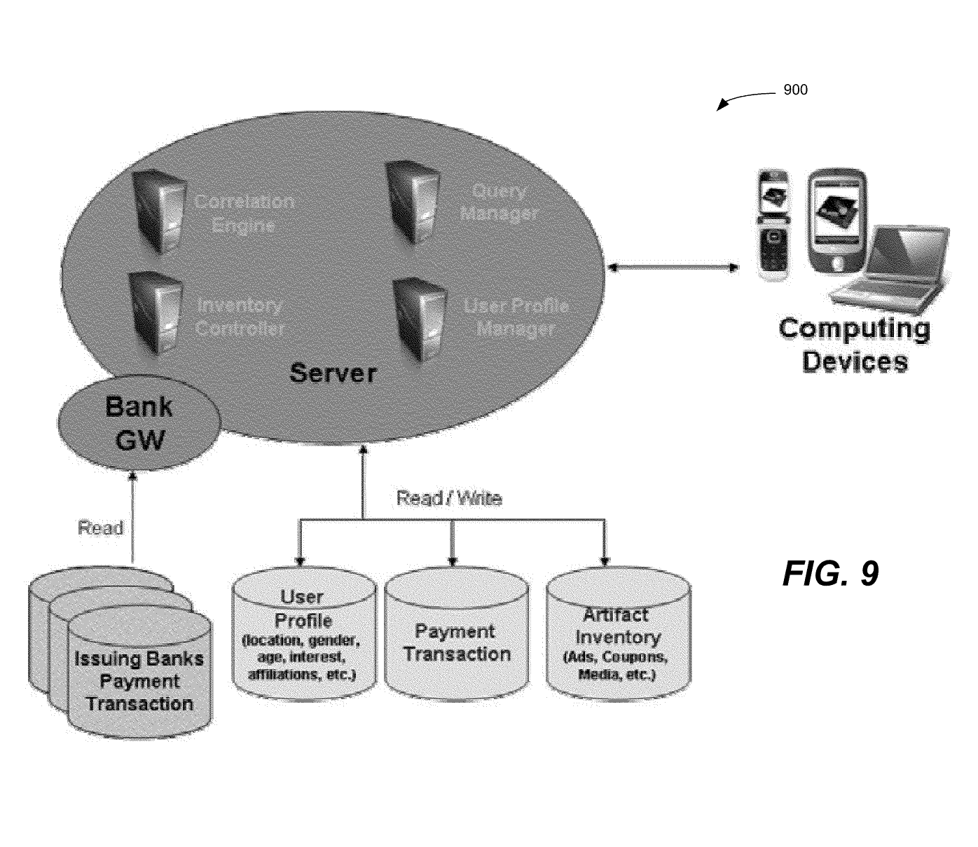

FIG. 9 illustrates one implementation of a communication system 900. The communication system 900 includes computing devices and a management server (designated “server”). The management server includes a correlation engine, a query manager, a user profile manager, and an inventory controller. The management controller is in communication with a user profile database, a payment transaction history database, and an artifact inventory database. The management server is also in communication with a bank so that raw data may be downloaded from banks and stored in local storage. In one implementation, data-mining and reporting tools are leveraged by the management server to define aggregated reports. Additionally, aggregated data may be downloaded from banks that provide/support data-mining and ad-hoc reporting tools.

In operation, a user opens an application (e.g, a web-browser) on a computing device (a mobile communication device). The application queries the management Server for an artifact, providing pageId (scene identifier) and userId, where the pageId can represent a specific screen, scene or real-estate property. The query can be initiated/triggered via following mechanisms, but not limited to: Browsing a particular screen/web-page that specify unique real-estate; leveraging proximity services (NFC/Contactless, etc.) that specify unique code or identifier; geographic location (LBS, Bluetooth, etc.). The management server collects targeting Meta Data based on the user's userId. The management server leverages multiple data sources including, but not limited to: user profiles (e.g., for location, gender, age, interest, affiliations, etc.); payment transactions (e.g., for top 5 spend categories, upcoming bill pay transactions, merchants, etc.). Leveraging payment transactions and banking transactions provides a good future trending of a user's behavior, including a level of importance/relevancy. Mining this data (for spend category, merchant, price level, etc.) provides a rich set of attributes that better describes a user's retail preference. The management server queries the artifact inventory against query parameters based on targeting meta data. If multiple matches are determine, the correlation engine uses predetermined business rules and identifies and returns a URL (Universal Resource Locator) to a unique artifact. The user (or consumer) can use the application running on the mobile communication device to retrieve artifact/content based on the provided URL.

Although the present invention has been particularly described with reference to implementations discussed above, various changes, modifications and substitutes are can be made. Accordingly, it will be appreciated that in numerous instances some features of the invention can be employed without a corresponding use of other features. Further, variations can be made in the number and arrangement of components illustrated in the figures discussed above.

1. A method, comprising:
receiving at a management server a request for a digital artifact from a mobile application, wherein the request is automatically triggered when a user browses a specific mobile application generated screen, the mobile application is not browser based and is a preinstalled or downloaded and installed on the mobile device, the mobile device comprising a mobile device display, a mobile device processor, a mobile device radio interface, and a mobile device wireless fidelity (Wi-Fi) interface, the specific mobile application generated screen corresponds to a specific screen, scene, or area of the mobile application;
selecting the digital artifact at the management server based on one or more targeting parameters stored at the management server, and
sending the digital artifact from the management server to the mobile application for display within the specific mobile application generated screen.

2. The method of claim 1, wherein the digital artifact is an advertisement, receipt, ticket, coupon, media, or content received at the mobile application.

3. The method of claim 1, wherein the request for the digital artifact is triggered by contactless services.

4. The method of claim 1, wherein the request for the digital artifact is triggered by a geographical location of the mobile device.

5. The method of claim 1, wherein the request for the digital artifact is automatically generated through a proximity-based interaction with a smart poster, a kiosk, or a point-of-sale device.

6. The method of claim 1, wherein the management server updates targeting parameters based on continuous updates of at least one of personal information or transactions stored at the management.

7. The method of claim 1, wherein targeting parameters comprises personal information and/or transactions.

8. The method of claim 6, 7, wherein personal information comprises location, gender, age, interest, affiliation ,userid, pageid, zip code, area code, and occupation.

9. The method of claim 6, 7, wherein transactions comprises historical payment transactions, real-time payment transactions, contactless transactions made using the mobile device, internet commerce, bill pay, top spend categories, merchants, storage of banking information, account balance, payment history, funds transfer , tickets, receipts, coupons, and transactions made by the user but not through the mobile device, and raw data downloaded from banks.

10. A management server, comprising:
a management server transceiver that receives a request for a digital artifact from a mobile application, wherein the request is automatically triggered when a user browses a specific mobile application generated screen, the mobile application is not browser based and is preinstalled or downloaded and installed on the mobile device, the mobile device comprising a mobile device display, a mobile device processor, a mobile device radio interface, and a mobile device wireless fidelity (Wi-Fi) interface, the specific mobile application generated screen corresponds to a specific screen, scene, or area of the mobile application;
a management server processor that selects the digital artifact based on one or more targeting parameters; and
a management server transceiver that sends the digital artifact for display within the specific mobile application generated screen.

11. The management server of claim 1, wherein the digital artifact is an advertisement, receipt, ticket, coupon, media, or content received at the mobile application.

12. The management server of claim 1, wherein the request for the digital artifact is triggered by contactless services.

13. The management server of claim 1, wherein the request for the digital artifact is triggered by a geographical location of the mobile device.

14. The management server of claim 1, wherein the request for the digital artifact is automatically generated through a proximity-based interaction with a smart poster, a kiosk, or a point-of-sale device.

15. The management server of claim 1, wherein the management server updates targeting parameters based on continuous updates of at least one of personal information or transactions stored at the management.

16. The management server of claim 1, wherein targeting parameters comprises personal information and/or transactions.

17. The management server of claim 6, 7, wherein personal information comprises location, gender, age, interest, affiliation ,userid, pageid, zip code, area code, and occupation.

18. The management server of claim 6, 7, wherein transactions comprises historical payment transactions, real-time payment transactions, contactless transactions made using the mobile device, internet commerce, bill pay, top spend categories, merchants, storage of banking information, account balance, payment history, funds transfer , tickets, receipts, coupons, and transactions made by the user but not through the mobile device, and raw data downloaded from banks.

19. A non-transitory computer readable medium, comprising:
computer code for receiving at a management server a request for a digital artifact from a mobile application, wherein the request is automatically triggered when a user browses a specific mobile application generated screen, wherein the mobile application is not browser based and is preinstalled or downloaded and installed on the mobile device, the mobile device comprising a mobile device display, a mobile device processor, a mobile device radio interface, and a mobile device wireless fidelity (Wi-Fi) interface, the specific mobile application generated screen corresponds to a specific screen, scene, or area of the mobile application;
computer code for selecting at the management server the digital artifact based on one or more targeting parameters; and
computer code for sending from the management server the digital artifact for display within the specific mobile application generated screen.

20. The computer code of claim 19, wherein the management server updates targeting parameters based on continuous updates of at least one of personal information or transactions stored at the management.
